(19) United States
(12) Patent Application Publication
(10) Pub. No.: US 2020/0000228 A1
(43) Pub. Date: Jan. 2, 2020

(54) Magnetic Furniture Leg Glide

(71) Applicant: Theresa Quintong, New York, NY (US)

(72) Inventor: Theresa Quintong, New York, NY (US)

(21) Appl. No.: 16/564,497

(22) Filed: Sep. 9, 2019

Related U.S. Application Data
(63) Continuation-in-part of application No. 16/021,196, filed on Jun. 28, 2018.
(60) Provisional application No. 62/525,790, filed on Jun. 28, 2017.

(51) Int. Cl. A47B 91/08; F16B 1/00; A47B 91/06

(52) U.S. Cl. CPC A47B 91/08; F16B 2001/0035; A47B 91/06; F16B 1/00

(57) ABSTRACT

A magnetic leg glide apparatus for holding an outdoor furniture article against a ground surface in windy weather conditions includes a bottom portion having a disc shaped configuration constructed of a magnetic material and at least one upstanding member coupled to and extending upwardly from a top surface of the bottom portion. The upstanding member is configured for receipt into an interior area of the furniture article. The upstanding member may be a single shaft configured to impale the interior of the chair leg or a plurality of upstanding walls arranged in a circular and annular pattern for friction fit receipt in the interior area of the furniture article.

### REFERENCE TO RELATED APPLICATIONS

This application claims the benefit of non-provisional patent application Ser. No. 16/021,196, filed Jun. 28, 2018, titled Magnetic Furniture Leg Glide, which claims the benefit of provisional patent application U.S. Ser. No. 62/525,790 filed Jun. 28, 2017 titled “Magnetic Furniture Leg Glide,” all of which are incorporated in their entireties herein by reference.

### BACKGROUND OF THE INVENTION

This invention relates generally to furniture leg gliders and, more particularly, to a magnetic leg glide apparatus for holding an outdoor furniture article against a ground surface in windy weather conditions.

There was a time when outdoor furniture was routinely constructed of thick metal arrangements that were immovable in windy conditions. Unfortunately, metal outdoor furniture was, therefore, heavy and difficult for a user to move without assistance or, at least, great effort. More recently, outdoor furniture, such as chairs and tables, are constructed of lightweight plastic materials. Although easier to move around during use or even in transport, the lightweight furniture is often overturned or completely blown away by high wind conditions.

Therefore, it would be desirable to have a magnetic leg glide apparatus that not only protects against furniture legs scratching a floor surface when the furniture is moved, but that inhibits or prohibits the furniture from movement during high winds. Further, it would be desirable to have a magnetic leg glide apparatus having a plurality of glide members for receiving the legs of outdoor furniture, respectively, that are also magnetic.

### SUMMARY OF THE INVENTION

A magnetic leg glide apparatus for holding an outdoor furniture article against a ground surface in windy weather conditions according to the present invention includes a bottom portion having a disc shaped configuration constructed of a magnetic material and at least one upstanding member coupled to and extending upwardly from a top surface of the bottom portion. The upstanding member is configured for receipt into an interior area of the furniture article. The upstanding member may be a single shaft configured to impale the interior of the chair leg or a plurality of upstanding walls arranged in a circular and annular pattern for friction fit receipt into the interior area of the furniture article.

Therefore, a general object of this invention is to provide a magnetic leg glide apparatus for holding an outdoor furniture article against a ground surface in windy weather conditions.

Still another object of this invention is to provide a magnetic leg glide apparatus, as aforesaid, that is removably coupled by insertion into a leg of an outdoor furniture article.

Yet another object of this invention is to provide a magnetic leg glide apparatus, as aforesaid, in which a glide member is constructed, in part, of magnetically attractive material that is attracted to a metal or magnetic material that may be positioned in a ground or floor surface beneath the glide member.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a representative base member known in the prior art;

FIG. 2 is a perspective view of a glide member according to a preferred embodiment of the prior art;

FIG. 3a is an upper perspective view of a variation of the glide member as in FIG. 2;

FIG. 3b is a lower perspective view of the glide member of FIG. 3a;

FIG. 4a is an exploded view of the glide member as in FIG. 3a being installed on an outdoor lawn furniture article, i.e. on a patio chair;

FIG. 4b is an isolated view on an enlarged scale taken from FIG. 4a;

FIG. 4c is an exploded view from a lower angle of the glide member as in FIG. 4a being installed on an outdoor lawn furniture article, i.e. on a patio chair;

FIG. 4d is an isolated view on an enlarged scale taken from FIG. 4c; and

FIG. 5 is an exploded view of the glide member as in FIG. 2 being installed on an outdoor lawn furniture article, i.e. on a patio chair.

### DESCRIPTION OF THE PREFERRED EMBODIMENT

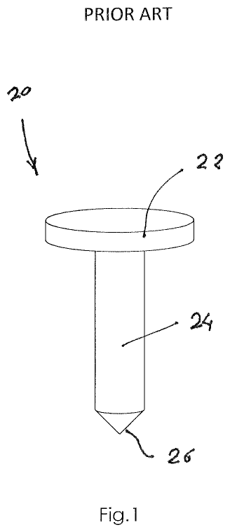

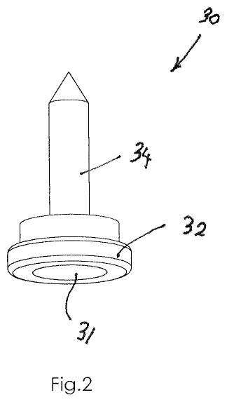

A magnetic leg glide apparatus according to a preferred embodiment of the present invention will be described with reference to FIGS. 1 to 5 of the accompanying drawings. The magnetic leg glide apparatus includes a glide member 30, each glide member being magnetically attracted to a base or floor surface and configured to secure the legs 13 of patio furniture, such as a plastic chair 12, against movement even in high wind conditions.

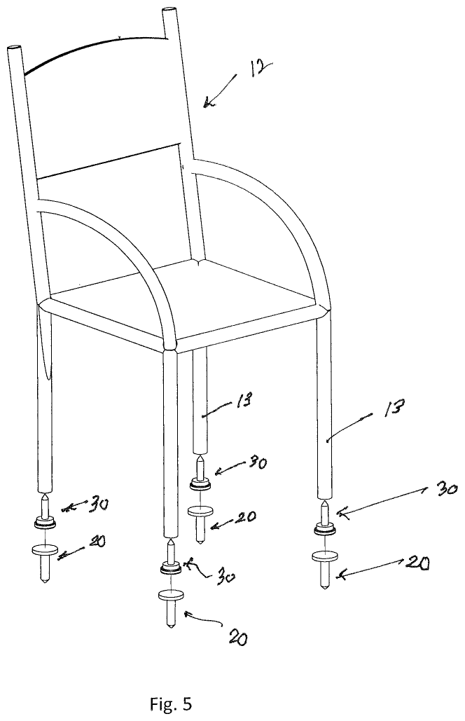

Although not a component of the present invention, the prior art includes magnetic base members 20 that may be used with the glide members of the present invention as will be described later. A suitable base member 20 is, in its simplest form, a circular or disc-shaped top plate with a downwardly extending anchor that may be anchored into a patio, deck, or floor surface, the top plate being magnetic. More particularly, the base member 20 may include a mounting plate 22 having a planar or flat configuration that will lay flat against a floor, patio, deck, or other flat surface. In fact, it is preferred that the base member 20 be installed at a slightly recessed configuration so as not to create a trip hazard when no glide member 30 is coupled thereto and also to enable a glide member 30 to move slidably onto a base member 20 without having to lift up the furniture and glide member 30 itself (FIG. 5). Preferably, the mounting plate 22 has a circular configuration that is very thin although other configurations may also be suitable. The mounting plate 22, or at least a top surface of the mounting plate 22, is constructed of a magnetic material. For instance, the top surface of the mounting plate may itself be a magnet such that another magnet having an opposite polarity or a conductor such as metal will be magnetically attracted to the mounting plate 22 as will be described later.

In some cases, the base member may include a downwardly extending anchor as a fastener 24 having a generally linear configuration. The fastener 24 may have a threaded surface to enhance its ability to burrow or drill into a surface and also to make it more difficult to be inadvertently pulled and removed. A common fastener 24 has a pointed tip 26. The fastener 24 is perpendicular to the mounting plate 22 and coupled to the bottom surface or underside of the mounting plate 22.

In an exemplary embodiment, a glide member 30 includes a base portion having a bottom wall 32 that includes a magnet 31 or otherwise constructed of a material that is attracted to a magnet of a mounting plate 22 of a base member 20 according to the construction described above. The bottom wall 32 may have a circular configuration as shown (like a disc) although a square or other configuration would also work. The glide member 30 includes an upstanding member configured as a leg shaft 34 having a linear configuration extending upwardly away from a center point of a top surface of the bottom wall 32 and that is configured either to impale a solid or closed leg end or simply to be frictionally inserted into an open leg end of a furniture article 12. (FIG. 5). The leg shaft 34 may or may not be threaded and may include a pointed tip which is especially advantageous if impaling a solid core chair leg. In the manner described above, the bottom wall 32 and the mounting plate 22 of a base member 20 are magnetically attracted toward one another (FIG. 5).

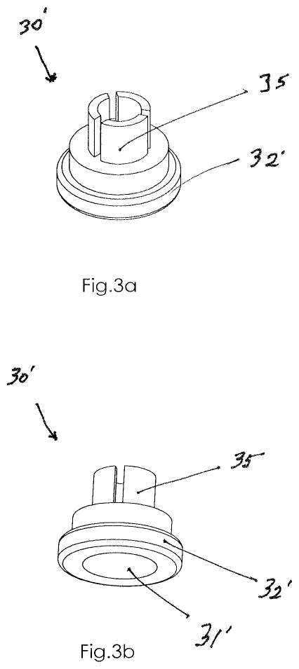

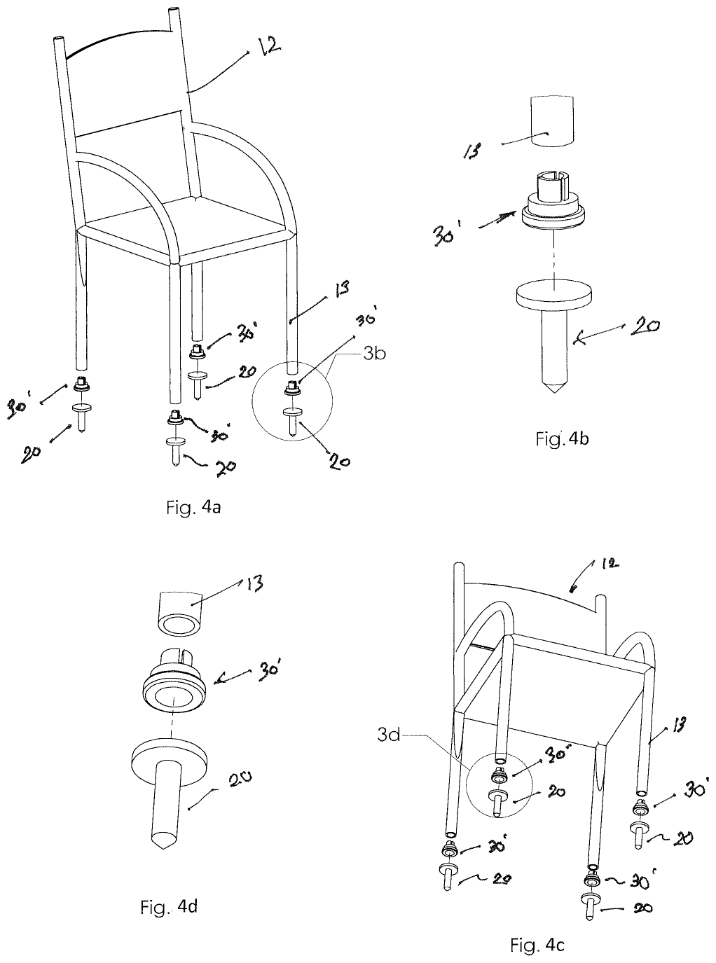

In a related exemplary embodiment, a glide member 30′ includes a base portion having a bottom wall 32′ that includes a magnet 31′ or otherwise constructed of a material that is attracted to a magnet of a mounting plate 22 of a base member 20 (FIG. 3a) according to the construction described above. The base portion may have a circular configuration as shown (like a disc) although a square or other configuration would also work. By contrast to the embodiment first described above, the upstanding side wall includes a plurality of angular upstanding walls 35 extending upwardly from the bottom wall 32′. Each angular upstanding wall 35 has an inwardly curved and partially annular configuration and is spaced apart from an adjacent angular upstanding wall 35. Together, the plurality of angular upstanding walls 35 form a circular configuration having a diameter slightly smaller than a diameter of a hollow chair leg 13 such that the glide member 30′ is received into the hollow leg 13 in a friction fit engagement (FIG. 4a).

In use, a glide member 30, 30′ may be inserted into the inner area of a leg 13 of a chair 12 and, preferably, the leg shaft 34 of glide member 30 is capable of impaling the inner core of a solid furniture leg or leg that is otherwise plugged. Similarly, the glide member 30′ may also be received in a friction fit manner into the inner area of a chair leg 13.

It is understood that while certain forms of this invention have been illustrated and described, it is not limited thereto except insofar as such limitations are included in the following claims and allowable functional equivalents thereof.

1. A magnetic leg glide apparatus for holding an outdoor furniture article having at least a leg against a magnetic base member on a floor or ground surface in windy weather conditions, said magnetic leg glide apparatus comprising:
a glide member including a bottom portion having a disc shaped configuration constructed of a magnetic material and an upstanding member extending upwardly from said base member for receipt into the leg of the outdoor furniture article.

2. The magnetic leg glide apparatus as in claim 1, wherein said upstanding member is a leg shaft that extends upwardly from a center point of a top surface of said bottom portion.

3. The magnetic leg glide apparatus as in claim 2, wherein said leg shaft has a linear configuration.

4. The magnetic leg glide apparatus as in claim 1, wherein said upstanding member includes a plurality of angular upstanding walls, each angular upstanding wall having a curved configuration and being spaced apart from an adjacent angular upstanding wall.

5. The magnetic leg glide apparatus as in claim 4, wherein each angular upstanding wall includes a partially annular configuration and, together, said plurality of angular upstanding walls are arranged in a circular configuration having a diameter for receipt into an interior of the leg of the outdoor furniture article in a friction fit configuration.

6. A magnetic leg glide apparatus for holding an outdoor furniture article having at least a leg against a magnetic base member on a floor or ground surface in windy weather conditions, said magnetic leg glide apparatus comprising:
a glide member including a bottom portion having a disc shaped configuration constructed of a magnetic material and a plurality of angular upstanding walls extending upwardly from said bottom portion, each angular upstanding wall having a curved configuration and being spaced apart from an adjacent angular upstanding wall.

7. The magnetic leg glide apparatus as in claim 6, wherein said plurality of angular upstanding walls are arranged in a circular configuration having a diameter for receipt into an interior of the leg of the outdoor furniture article.
